(19) United States
(12) Patent Application Publication
(10) Pub. No.: US 2006/0104646 A1
(43) Pub. Date: May 18, 2006

(54) Optoelectronic transmitting arrangement and optoelectronic receiving arrangement for parallel optical interconnects

(76) Inventor: Karl Schrodinger, Berlin (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/989,578

(22) Filed: Nov. 16, 2004

(51) Int. Cl. H04B 10/04

(52) U.S. Cl. 398/192

(57) ABSTRACT

The invention relates to an optoelectronic transmission arrangement for optical parallel connections. The transmission arrangement has: a first number (N) of electrical data channels that in each case transmit electrical input data; a second number (N+m) of optical transmitters, a transmitter in each case being able to convert the electrical signals of a data channel into optical signals, and the second number (N+m) being greater than the first number (N); a second number (N+m) of monitoring devices that are contained in the transmission arrangement and are in each case assigned to an optical transmitter; a control unit, which is connected to the second number (N+m) of monitoring devices and detects if an optical transmitter is not operating in accordance with a predefined operating specification, and a switch with a first number (N) of inputs and a second number (N+m) of outputs, the switch distributing the data of the first number (N) of electrical data channels between an identical number (N) of optical transmitters, at least one optical transmitter receiving no data and providing a redundant transmission channel. The control unit, for the case where an optical transmitter is no longer operating correctly, transmits a control signal to the switch and the latter switches over the data of the corresponding data channel to one of the redundant transmission channels in a manner dependent on said control signal. The invention furthermore relates to a corresponding optoelectronic reception arrangement.

The invention relates to an optoelectronic transmission arrangement and an optoelectronic reception arrangement for optical parallel connections. In particular, the invention relates to an optoelectronic transmission arrangement and an optoelectronic reception arrangement which improve the failure protection in the case of optical parallel connections by addition of redundant channels.

### BACKGROUND OF THE INVENTION

Optical parallel connections are known. Such connections are used for example for high-speed connections in LANs and SANs. Corresponding parallel optical modules generally have VCSEL transmitter linear arrays for the transmitter end and also integrated PIN or MSM detector linear arrays for the reception end.

Parallel optical modules are sold for example by Infineon Technologies AG under the designation PAROLI®. Electrical input and output stages of the modules are generally designed as LVDS (Low Voltage Differential Signals) according to IEEE 1596.3-1996. The transmission modules use VCSEL lasers having a wavelength of 840 nm. The transmission links are realized by means of 12-fold fiber ribbons having a length of up to 300 m which comprise multimode fibers with a graded index profile. The fiber ribbons are connected to the transmission and reception modules by means of MT-based optical connectors.

The known parallel optical modules exhibit the problem that when a transmitter fails, the whole system no longer functions or functions only with reduced quality. Therefore, there is a need for optoelectronic transmission arrangements and optoelectronic reception arrangements which provide an improved failure protection.

### SUMMARY OF THE INVENTION

The present invention provides, in a first aspect, an optoelectronic transmission arrangement, which has the following features:
a first number (N) of electrical data channels that in each case transmit electrical input data,
a second number (N+m) of optical transmitters, a transmitter in each case being able to convert the electrical signals of a data channel into optical signals, and the second number (N+m) being greater than the first number (N),
a second number (N+m) of monitoring devices that are contained in the transmission arrangement and are in each case assigned to an optical transmitter,
a control unit, which is connected to the second number (N+m) of monitoring devices and detects if an optical transmitter is not operating in accordance with a predefined operating specification,
a switch with a first number (N) of inputs and a second number (N+m) of outputs, the switch distributing the data of the first number (N) of electrical data channels between an identical number (N) of optical transmitters, at least one optical transmitter of the second number (N+m) of optical transmitters receiving no data and providing a redundant transmission channel.
The control unit, for the case where an optical transmitter is not operating in accordance with its predefined operating specification, transmits a control signal to the switch and the latter switches the data of the corresponding data channel to one of the redundant transmission channels in a manner dependent on said control signal.

Accordingly, the present invention is based on the concept of reducing the failure protection in the case of optoelectronic transmission arrangements for optical parallel connections by the addition of redundant transmission channels, a changeover from a defective channel to a redundant channel being effected in the transmission arrangement itself. By virtue of the detection of the failure of one or more channels in the transmission arrangement itself and by virtue of a corresponding changeover to a redundant transmission channel likewise in the transmission arrangement itself, a dependence on an external signalling is avoided. In particular, the solution according to the invention manages without the requirement of providing an additional return channel between the reception arrangement and the transmission arrangement and without the requirement of intervening in the protocol level of the system. The transmission arrangement is able to change over completely autonomously to a new channel if one of the channels fails or the associated optical transmitter is no longer operating within predefined operating specifications.

In one preferred refinement, each monitoring device comprises a monitor diode that detects a portion of the light emitted by the associated optical transmitter.

The monitor diode detects if the assigned optical transmitter is transmitting no optical power or an excessively low optical power.

In a further preferred refinement, each monitoring device also comprises, in addition to the monitor diode, a local transmitter control circuit that is connected to the monitor diode and transmits a control signal to the control unit if the associated optical transmitter is no longer operating or is no longer operating in accordance with a predefined operating specification. In this case, it may be provided that the transmitter control device can also detect present operating parameters of the optical transmitter, such as, for example, the driver current of a laser diode.

For the case where an optical transmitter is not operating or is not operating in accordance with a predefined operating specification, the control unit transmits a control signal for switching off the optical transmitter to the latter.

Furthermore, the control unit preferably transmits a control signal to the switch for conducting data to a different, redundant optical transmitter only after the previous optical transmitter has been switched off for a defined time. This waiting time enables the receiver circuit to reliably detect the failure of the transmitter and, for its part, to bypass the corresponding channel. Instead of a waiting time, it is also possible to effect an internal signalling (e.g. a specific number of defined pulses) via the redundant channel in order that the receiver reliably identifies the desire for changeover of the transmitter.

Furthermore, the control unit, after the defined time has elapsed, preferably additionally transmits a control signal for switching on the redundant optical transmitter directly to the latter. As an alternative, the transmitter may also have a self-activation in the case of driving by the switch.

In an advantageous refinement of the switch, the switch comprises a third number (m) of subswitches that in each case have a first number (N) of inputs and an output, the inputs being connected to the first number (N) of data channels and a subswitch, in the case of activation by a control command of the control unit, through-connecting one of its inputs to the output. In this case, the third number (m) is equal to the number of redundant channels. The subswitches may also be referred to as multiplexers. It is pointed out, however, that numerous other configurations of the switch are also conceivable. All that is important is that the switch can switch the input data of the N electrical data channels to a subset of the larger number of (regular and redundant) transmission channels in a manner dependent on control signals of the control unit.

Preferably, the control unit is connected to a non-volatile memory in which status information items relating to the active optical transmitters and also changes in the status information items are stored.

The invention provides, in a second aspect, an optoelectronic reception arrangement, which has the following elements:
a first number (N) of electrical data channels that in each case transmit electrical output data,
a second number (N+m) of optical data inputs, the second number (N+m) being greater than the first number (N),
a second number (N+m) of optical receivers that are in each case connected to one of the optical data inputs, each optical receiver being able to detect optical input signals present at the associated optical data input and to convert them into electrical signals, and only a subset (N) of the optical receivers detecting optical signals at an instant under consideration, while at least one remaining optical receiver provides a redundant reception channel; said subset (N) here is equal to the first number (N), i.e. equal to the number of electrical data channels,
a control unit, which is connected to the optical receivers and detects if a receiver that has previously received data is no longer receiving data,
a switch with a second number (N+m) of inputs and a first number (N) of outputs, the switch distributing the data received by the subset (N) of the optical receivers between the first number (N) of electrical data channels.
The control unit, for the case where an optical receiver is no longer receiving data, transmits a control signal to the switch and the switch, in a manner dependent on said control signal, applies the data of a different input and optical receiver to the electrical data channel that has previously received the data of the optical receiver that is now no longer receiving data.

In the case of the reception arrangement according to the invention, too, a failure of a receiver is detected completely autonomously in the reception module and a changeover to a different data output is effected directly in the reception module, once again without an external signalling.

In a preferred refinement of the reception arrangement, it is provided that each optical receiver has a signal detect line that indicates whether the receiver is currently detecting optical signals. The control unit is connected to the signal detect lines and detects, with the aid of the latter, if a receiver that has previously received data is no longer receiving data. The provision of signal detect lines is known in the prior art, and so this will not be discussed in any greater detail.

In a further preferred refinement, the control unit checks whether—once one of the optical receivers is no longer receiving data—data are now being received on one of the redundant reception channels, and, for this case, transmits a control signal to the switch to apply this reception channel to the electrical data channel in question. The information that a different one of the receivers is detecting optical signals is provided in particular by the signal detect line of the corresponding receiver.

It is furthermore preferably provided that the control unit transmits a control signal to the switch for selection of a redundant reception channel only after the previous optical receiver has not received any data for a defined time (waiting time). This ensures that a changeover to a different reception channel is not effected in the case of just one signal fluctuation. Instead of the waiting time, it is also possible to receive an internal signalling (e.g. a specific number of defined pulses) via the redundant channel in order that the receiver reliably identifies the desire for changeover of the transmitter.

In a preferred exemplary embodiment, the switch comprises a first number (N) of subswitches that in each case have a plurality (m+1) of inputs and an output, the inputs being connected to all the redundant reception channels to a further reception channel, (one of the “regular” reception channels). A subswitch through-connects a different one of its inputs to its output as a result of a control command of the control unit. The subswitches may also be referred to as multiplexers.

The control unit is preferably connected to a non-volatile memory in which status information items relating to the optical receivers that detect optical signals and relating to the active reception channels and also changes in the status information items are stored.

### BRIEF DESCRIPTION OF THE DRAWINGS

The invention is explained in more detail below on the basis of a plurality of exemplary embodiments with reference to the figures, in which:

FIG. 1 shows a block diagram of an optoelectronic transmission arrangement for optical parallel connections with a transmission unit, a control unit and a switch;

FIG. 2 shows an exemplary embodiment of the switch of FIG. 1;

FIG. 3 shows an exemplary embodiment of an optical transmitter for a data channel of the transmission unit of FIG. 1;

FIG. 4 shows a flow diagram of steps that are executed in the transmission arrangement of FIG. 1;

FIG. 5 shows a block diagram of an optoelectronic reception arrangement for optical parallel connections with a reception unit, a control unit and a switch;

FIG. 6 shows an exemplary embodiment of the switch of FIG. 5; and

FIG. 7 shows a flow diagram of steps that are executed in the reception arrangement of FIG. 5.

### DESCRIPTION OF A PLURALITY OF PREFERRED EXEMPLARY EMBODIMENTS

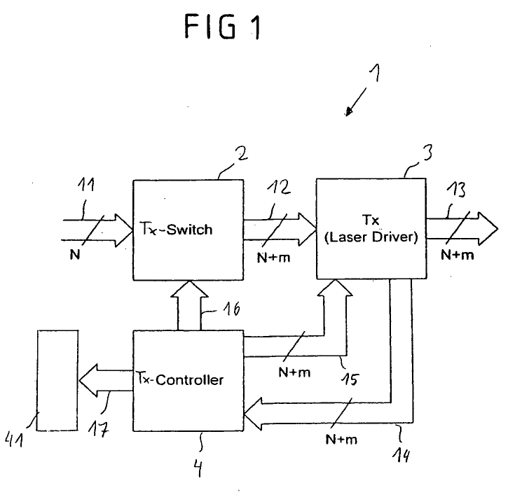

FIG. 1 schematically shows an optoelectronic transmission arrangement 1 for optical parallel connections, which has a switch 2, an optical transmission unit 3 and a control unit (controller) 4. The electrical input signals of a first number N of electrical data channels 11 are present at inputs of the switch 2. A second number N+m of data lines 12 to the transmission unit 3 are present at the output of the switch.

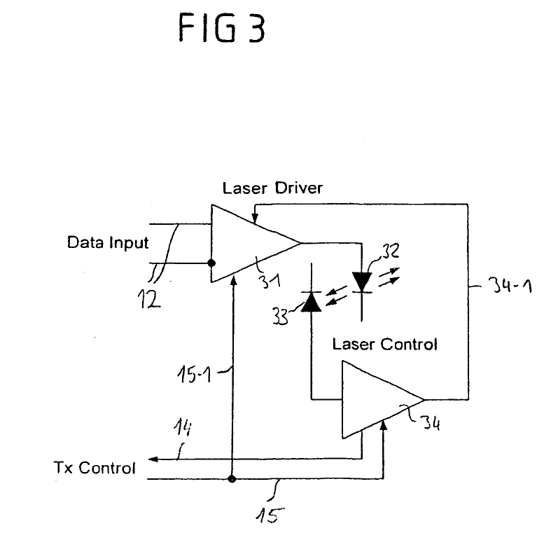

The transmission unit 3 has a multiplicity N+m of optical transmitters, which are preferably laser diodes, in particular vertically emitting laser diodes in an array arrangement. An individual one of such optical transmitters and an associated laser control circuit are illustrated by way of example in FIG. 3.

The number N+m of optical transmitters of the transmission unit 3 is greater than the number of data channels N, that is to say that at least one redundant transmission channel is present. The number “m” indicates the number of redundant transmission channels. The transmission unit 3 thus provides N+m optical data outputs or optical transmission channels 13, in which case, however, there is only ever a maximum N of these transmission channels, that is to say corresponding to the number N of electrical data channels, which transmit data at a given point in time. The remaining optical transmitters and associated transmission channels are kept as redundant channels. In this case, it is pointed out that redundant optical waveguides assigned to the redundant optical transmitters are also kept on the transmission link between the transmission arrangement 1 and an associated reception arrangement. The control unit 4 is connected to the transmission unit 3 via control lines 14, 15. In particular, it receives control signals relating to the operating state of the individual optical transmitters of the transmission unit 3 via control lines 14. Via control lines 15, the control unit 3 can transmit control commands to the individual optical transmitters, in particular relating to switching off or switching on an optical transmitter.

The control unit 4 detects whether the optical transmitters activated at a specific point in time are operating within a predefined operating specification, which naturally also includes whether the optical transmitters are actually transmitting light or an optical transmitter has possibly failed.

If an optical transmitter fails, or if a different deviation from a predefined operating specification is present, then the control unit 4 receives a corresponding control signal from the transmission unit 3. The signal is preferably provided by a transmitter control device that is assigned to the optical transmitter and is described by way of example in FIG. 3.

The control unit 4 then first of all causes the defective transmitter or channel to be switched off. The switch-off is effected by means of a control signal on one of the control lines 15.

Secondly, the control unit outputs a control signal (switch control signal) on control lines 16 to the switch 2, which causes the latter now to conduct the data of the affected data channel to a different optical output or a different optical transmitter. This is preferably effected after a specific waiting time, which permits the reception arrangement at the other end of the data transmission link to switch over to a different receiver.

As an alternative, immediately after the defective transmitter has been switched off the control unit causes the data of the affected data channel now to be conducted to a different optical transmitter. The latter firstly transmits a specific signalling on the basis of which the receiver recognizes that data will now be transmitted on a different channel.

In this case, a selection criterion for a changeover to a different optical transmitter may also be, in addition to an excessively low optical power of the previous laser, an excessively high driver storm if the optical power is kept constant—for example by means of a monitor diode.

The switch 2 has N inputs and N+m outputs. It can forward the data of the N incoming electrical data channels 11 on a total of N+m lines 12, only N outputs being occupied by data at a given point in time, however. The switch 2, on the basis of the control signals of the control unit 4, defines the optical transmitters and transmission channels to which the data to be transmitted are conducted.

The information items concerning the activated optical transmitters and also status changes are preferably stored in a non-volatile memory 41, to which the control unit 4 is connected via lines 17 or which is integrated in the control unit 4.

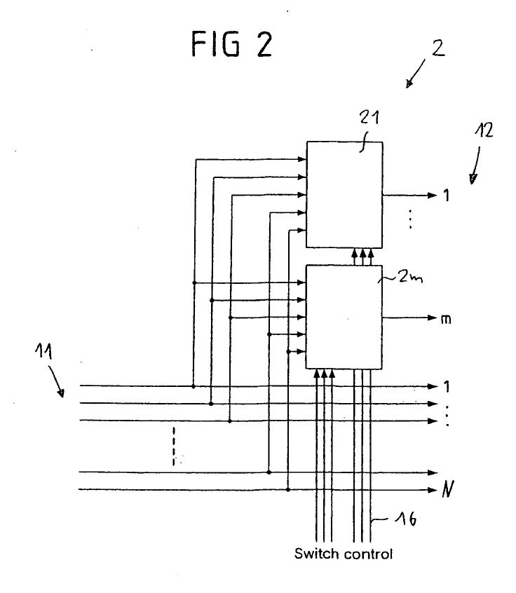

FIG. 2 shows a possible exemplary embodiment of the switch of FIG. 2. N incoming data channels 11 (data channels 1 to N) are illustrated, on which input data (electrical input data signal) are fed to the switch. m redundant data channels 1 to m are additionally illustrated. A subswitch 21, 2m is in each case provided for each of the redundant data channels 1 to m. Each subswitch 21, 2m has N inputs and an output. The inputs are connected to all the electrical data channels 1 to N. The subswitch 21, 22 switches one of the inputs to the output in a manner dependent on control signals 16 (switch control) of the control unit 4, a redundant channel that replaces a failed channel being provided for this case. The data of the N incoming data channels 11 can thus be forwarded on N+m lines 12, in which case there are only ever N outputs which are occupied by data at a given point in time.

FIG. 3 shows an exemplary embodiment of an optical transmitter. The transmitter has a laser driver 31, the electrical data of one of the data channels being applied to the input of said laser driver. The laser driver drives a laser diode 32, which emits a modulated optical signal in accordance with the modulation of the electrical signals. The laser diode 32 is a vertically emitting laser diode, by way of example. A monitor diode 33 and a laser control circuit 34 are furthermore provided, which form a local monitoring device assigned to the transmitter. The monitor diode 33 detects a fraction of the light emitted by the transmission diode 32 and conducts this to the laser control unit 34. The latter generates from this a control signal “TX-control”, which it transmits to the control unit 4 via a control line 14. By means of a control signal “TX Enable” on a control line 15-1, the control unit 4 can switch on or switch off the driver 31 and thus the transmitter.

By means of the light power measured by the monitor diode 33, it is possible, moreover, for the light power of the laser diode 32 to be kept constant in the context of a regulation. This is indicated by means of a control line 34-1 from the laser control unit 34 to the laser driver 31. In this case, a “TX control” control signal which encodes a defective operation of the laser can be output to the control unit 4 even when, by way of example, the driver current assumes excessively high values given a constant light power.

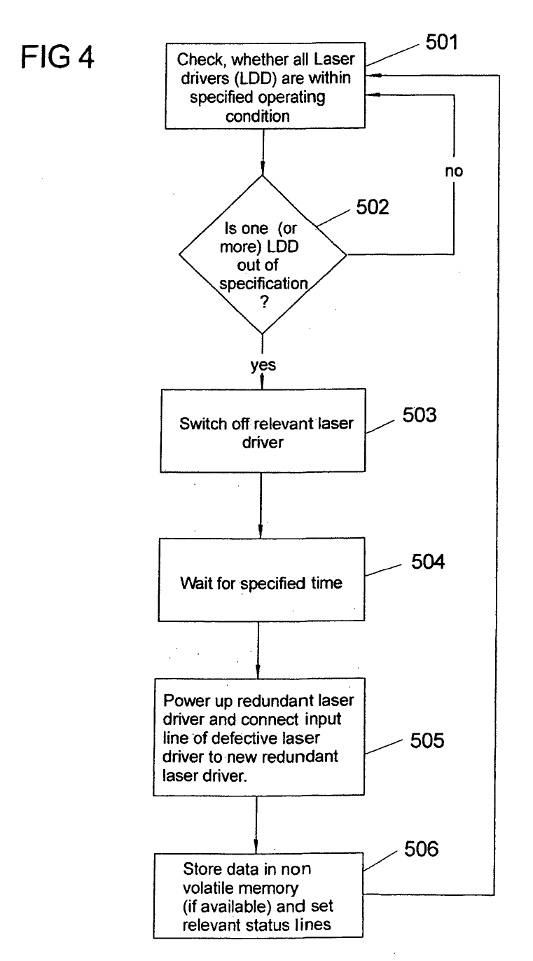

FIG. 4 illustrates the flow diagram of the individual steps. Firstly, in step 501, a check is made to determine whether the laser driver 31 is being operated within the predefined operating specification. For the purpose of this check, the laser control unit 34 evaluates the signal of the monitor diode 33. The laser driver 32 is not operated within the predefined operating specification particularly when the laser diode has become defective and fails. However, as already mentioned, a failure criterion may also be, in addition to an excessively low or an absent optical power, detected by the monitor diode 33, an excessively high driver current if the optical power is kept constant by means of the monitor diode 33.

If one or a plurality of laser drivers are out of the predefined operating specification, the respective laser driver is switched off in step 503. A specific waiting time or signalling is then effected, which is necessary in order that the receiver can also definitively detect the failure and, for its part, bypass the corresponding channel (step 504). In step 505, after the waiting time has elapsed, the switch 2 switches the data of the failed channel to a redundant channel and forwards them to the corresponding laser driver. Furthermore, the corresponding redundant laser driver is switched on by means of a control signal of the control unit 4. In step 506, the data are preferably stored in the non-volatile memory 41 and the relevant status connections are set anew. In this case, in particular data relating to the switching off of the previous laser driver and the switching on of a new laser driver are stored.

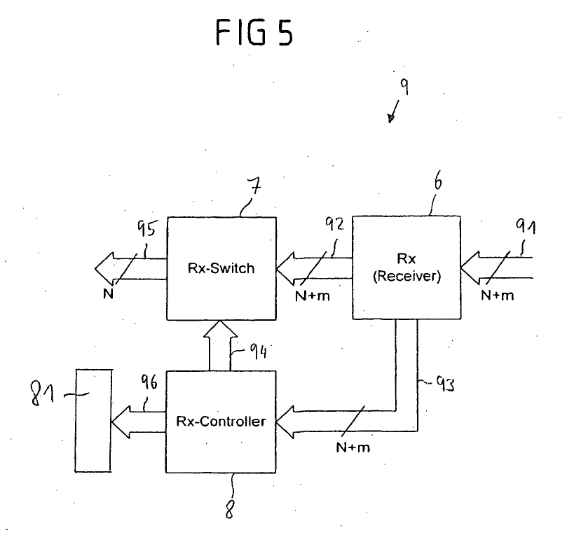

FIG. 5 shows the optical reception device 9, which receives the data transmitted by the lasers of the transmission device 1 after said data have been transmitted via optical waveguides (not illustrated) via a transmission link. For this purpose, N+m optical waveguides are provided, which are plugged into the reception device (and the transmission device) via an optical connector. N optical waveguides serve for the transmission of the data. The remaining m optical waveguides are redundant and are kept in reserve. N+m optical data inputs 91 are present at the reception device 9.

The reception device 9 has a reception unit 6, a switch 7 and a control unit 8, which are connected by data lines 92 and control lines 93, 94 in accordance with FIG. 1. The control unit 8 is connected to a non-volatile memory 81 or integrates such a memory.

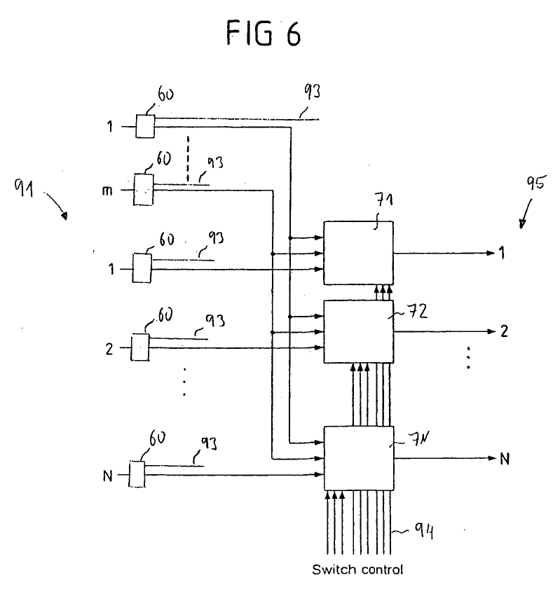

As can be gathered from FIG. 6, the reception device 6 has N+m optical receivers 60, which preferably comprise photodiodes. The N+m optical receivers 60 are assigned to the N+m optical data inputs 91. In this case, each optical receiver 60 has circuit means or is connected to circuit means which provide a signal detect line. Such signal detect lines 93 are illustrated schematically in FIG. 6 and known to the person skilled in the art.

Consequently, a reception photodiode is assigned to each “regular” optical channel 1 . . . N and to each redundant channel 1 . . . m. Naturally, however, in accordance with the number of data channels, optical signals are only applied to N of the optical waveguides or only N optical receivers 60 receive optical signals.

The reception unit 6 can notify the control unit 8 of the respective data reception status via the signal detect lines 93 for each channel individually. If a channel fails for a specific period of time and if a signal is detected for a redundant channel instead, then the switch 7 is switched, in a manner dependent on control signals of the control unit 8, in such a way that the detected data present on the redundant channel are forwarded.

For this purpose, N subswitches 71, 72 . . . 7N are provided in the exemplary embodiment of FIG. 6, each subswitch having inputs with respect to one of the regular data channels and with respect to all the redundant data channels 1 . . . m and also precisely one output. In accordance with the control signals 94 of the control unit 8, one of the inputs of the subswitch is switched to the output, either the regular channel or—in the event of the failure thereof—one of the redundant channels. In this case, the reception device 9 autonomously ascertains which redundant channel is chosen as replacement for the failed channel.

A total of N electrical outputs 95 (also cf. FIG. 5) are present, corresponding to the N electrical data channels 11 of the transmission device 1 of FIG. 1.

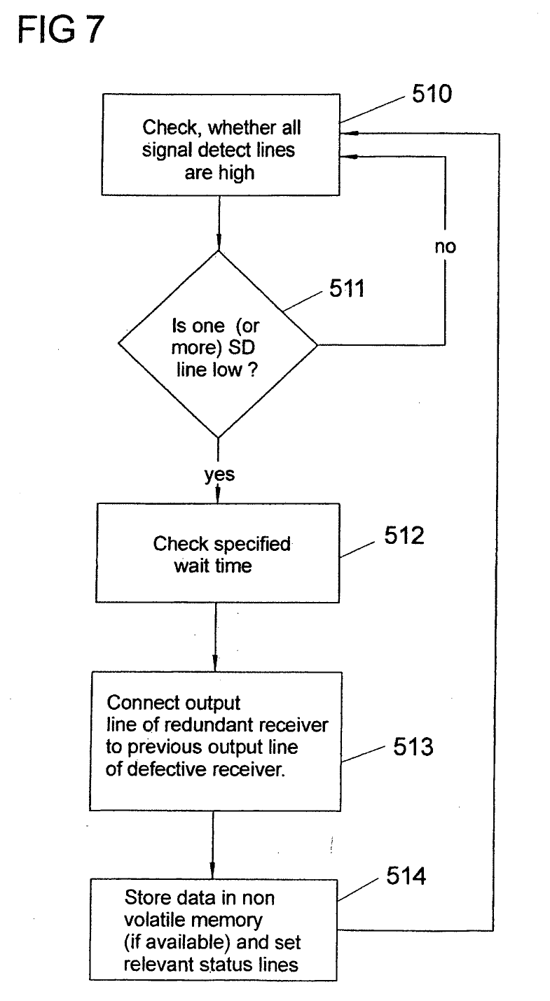

FIG. 7 shows the flow diagram. Firstly, in step 510, a check is made to determine whether all the signal detect lines of the regular data channels are set to HIGH, that is to say the corresponding photodiodes detect a signal. If one or a plurality of the signal detect lines are set to LOW (this is checked in step 511), then preferably firstly a specific waiting time (or alternatively the reception of a signalling that signals the use of a redundant channel) is awaited in step 512. A check is furthermore made to determine whether the signal detect line is now set to HIGH in the case of a different optical receiver. For this case, the control unit 8 outputs a control signal to the switch 7, which has the effect that the input signal of the redundant channel whose signal detect line is now at HIGH is conducted to the output to which the data of the failed channel were previously conducted, step 513.

The data relating to the abandoning of the previous channel and use of a redundant channel are preferably stored in the non-volatile memory 81 and the relevant status lines are set anew, step 514.

The configuration of the invention is not restricted to the exemplary embodiments illustrated above. The person skilled in the art recognizes that numerous alternative embodiment variants exist which, despite their deviation from the exemplary embodiments described, make use of the teaching defined in the subsequent claims.

1. An optoelectronic transmission arrangement for optical parallel connections, comprising:
a first number of electrical data channels that in each case transmit electrical input data,
a second number of optical transmitters, a transmitter in each case being able to convert the electrical signals of a data channel into optical signals, and the second number being greater than the first number,
a second number of monitoring devices that are contained in the transmission arrangement and are in each case assigned to an optical transmitter of the second number of optical transmitters,
a control unit, which is connected to the second number of monitoring devices and detects if an optical transmitter is not operating in accordance with a predefined operating specification,
a switch with a first number of inputs and a second number of outputs, the switch distributing the data of the first number of electrical data channels between an identical number of optical transmitters, at least one optical transmitter of the second number of optical transmitters receiving no data and providing a redundant transmission channel, and
the control unit, for the case where an optical transmitter is not operating in accordance with its predefined operating specification, transmitting a control signal to the switch and the latter switching the data of the corresponding data channel to a redundant transmission channel in a manner dependent on said control signal.

2. The transmission arrangement according to claim 1, wherein each monitoring device comprises a monitor diode that detects a portion of the light emitted by the associated optical transmitter.

3. The transmission arrangement according to claim 2, wherein each monitoring device comprises, in addition to the monitor diode, a transmitter control circuit that is connected to the monitor diode and transmits a control signal to the control unit if the associated optical transmitter is no longer operating in accordance with a predefined operating specification.

4. The transmission arrangement according to claim 1, wherein the control unit, for the case where a faulty optical transmitter is not operating in accordance with a predefined operating specification, transmits a control signal for switching off the faulty optical transmitter.

5. The transmission arrangement according to claim 4, wherein the control unit transmits the a control signal to the switch for conducting data to a, redundant optical transmitter only after the faulty optical transmitter has been switched off for a defined time.

6. The transmission arrangement according to claim 5, wherein the control unit, after the defined time has elapsed, additionally transmits a control signal for switching on the redundant optical transmitter directly.

7. The transmission arrangement according to claim 1, wherein the optical transmitter of a redundant transmission channel, after its activation, initially transmits signaling information items.

8. The transmission arrangement according to claim 1, wherein the switch comprises comprising a third number of subswitches that in each case have a first number of inputs and an output, the inputs being connected to the first number of data channels and a subswitch, in the case of activation by a control command of the control unit, through connecting one of its inputs to the output.

9. The transmission arrangement according to claim 1, wherein the control unit is connected to a non volatile memory in which status information items relating to the active optical transmitters and also changes in the status information items are stored.

10. An optoelectronic reception arrangement for optical parallel connections, comprising:
a first number of electrical data channels that in each case transmit electrical output data,
a second number of optical data inputs, the second number being greater than the first number,
a second number of optical receivers that are in each case connected to one of the second number of optical data inputs,
each optical receiver of the second number of optical receivers associated with one of the second number of optical data inputs being able to detect optical input signals present at the one optical data input and to convert the optical input signals into electrical signals,
only a subset of the optical receivers detecting optical signals at an instant under consideration, while at least one remaining optical receiver provides a redundant reception channel, said subset being equal to the first number,
a control unit, which is connected to the second number of optical receivers and detects if a receiver that has previously received data is no longer receiving data,
a switch with a second number of inputs and a first number of outputs, the switch distributing the data received by the subset of the optical receivers between the first number of electrical data channels, and
the control unit, for the case where a faulty optical receiver of the second number of optical receivers is no longer receiving data, transmitting a control signal to the switch and the switch, in a manner dependent on said control signal, applying the data of a different input and optical receiver to the electrical data channel that has previously received the data of the faulty optical receiver that is no longer receiving data.

11. The reception arrangement according to claim 10, wherein each optical receiver comprises a signal detect line that indicates whether the receiver is currently detecting optical signals, the control unit being connected to the signal detect lines and detecting, if a receiver of the second number of optical receivers that has previously received data is no longer receiving data.

12. The reception arrangement according to claim 10, wherein the control unit checks whether, once one of the optical receivers is no longer receiving data, data are now being received on one of the redundant reception channels, and, for this case, transmitting a control signal to the switch to apply this reception channel to the electrical data channel.

13. The reception arrangement according to claim 10, wherein the control unit transmits a control signal to the switch for selection of a redundant reception channel only after the previous optical receiver has not received any data for a defined time.

14. The reception arrangement according to claim 10, wherein the switch comprises a first number of subswitches that in each case have a plurality of inputs and an output, the inputs being connected to the redundant reception channels to a further reception channel, and a subswitch, as a result of a control command of the control unit, through connecting a different one of its inputs to its output.

15. The reception arrangement according to claim 10, wherein the control unit is connected to a non volatile memory in which status information items relating to the optical receivers that detect optical signals and also changes in the status information items are stored.

16. An optoelectronic arrangement comprising:
a plurality of channels;
a plurality of optical transmitters;
one or more redundant optical transmitters;
a switch that controllably connects the plurality of optical transmitters and the one or more redundant optical transmitters to the plurality of channels; and
a transmission control unit that identifies defective transmitters and properly operating transmitters of the plurality of optical transmitters, associates replacement optical transmitters of the one or more redundant optical transmitters with the identified defective transmitters, and causes the switch to turn off a first subset of the plurality of channels connected to the defective channels and turn on a second subset of the plurality of channels connected to the replacement optical transmitters.

17. The arrangement of claim 16, further comprising a plurality of data channels connected to the switch, wherein the switch connects the data channels to a third subset of the plurality of channels connected to the properly operating transmitters and the second subset of the plurality of channels.

18. The arrangement of claim 17, wherein the switch comprises a plurality of subswitches connected to the plurality of data channels that connect the data channels to the third subset of the plurality of channels and the second subset of the plurality of channels.

19. The arrangement of claim 17, wherein the plurality of optical transmitters comprise laser drivers connected to the plurality of data channels, laser diodes that emit optical signals, monitor diodes that detect the optical signals from the laser diodes, and laser control circuits connected to the monitor diodes that provide monitor signals to the transmission control unit.

20. The arrangement of claim 16, further comprising:
receive data channels;
a plurality of optical receivers connected to the plurality of channels;
one or more redundant optical transmitters connected to the plurality of channels;
a reception switch that controllably connects the plurality of optical receivers and the one or more redundant optical receivers to the receive data channels; and
a reception control unit that identifies the second subset and the third subset of the plurality of channels and controls the reception switch to connect the second subset and the third subset of the plurality of channels to the receive data channels.
